(19) United States
(12) Patent Application Publication
(10) Pub. No.: US 2007/0083611 A1
(43) Pub. Date: Apr. 12, 2007

(54) Contextual multimedia advertisement presentation

(75) Inventors: Julia H. Farago, Seattle, WA (US); Nicholas A. Whyte, Mercer Island, WA (US); Ewa Dominowska, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/246,776

(22) Filed: Oct. 7, 2005

(51) Int. Cl. G06F 15/16

(52) U.S. Cl. 709/217

(57) ABSTRACT

A contextual multimedia advertisement system and associated methods are disclosed. The architecture includes a component that determines content of a multimedia item, and a distribution component that facilitates presentation of one or more advertisements associated with the content. Additionally or alternatively, advertisement presentation, selection and/or generation can be based on context information pertaining to the item and/or end user as well as ratings influenced by advertisers, among other things. The one or more identified advertisements can be presented with the item at valuable points therein.

### BACKGROUND

The advent of the global communications network such as the Internet has provided users with a mechanism for obtaining information regarding virtually any content. For example, various websites are dedicated to posting text, images, and/or video relating to world, national, and/or local news. A user with knowledge of a uniform resource locator (URL) for a website can simply enter the URL into a browser and access content thereon. Another conventional manner of locating desired information from the Internet is through utilization of a search engine. For instance, a user can enter a word or series of words into a search field and thereafter initiate the search engine (e.g., through depression of a button, one or more keystrokes, voice commands. . . ). The search engine then utilizes search algorithms to locate websites related to the word or series of words entered by the user into the search field, and the user can then select one of the websites returned by the search engine to review content therein.

As more and more people utilize the Internet, it has rapidly become apparent to advertisers that revenue opportunities exist for small and large businesses, both content providers and advertisers alike. For instance, many retail companies utilize the Internet to sell goods online, thereby reducing costs associated with managing and maintaining a store location, providing an ability to centralize inventory, and various other similar benefits that result in decreased costs that are passed on to customers. Given this increased use of the Internet for generating business and/or revenue, the Internet can be further utilized as an advertising mechanism. In one example, an individual who may be interested in purchasing flowers enters the term “flower” into a search engine, thereafter receiving numerous “hits” on company websites that sells flowers.

Furthermore, a website can gain additional revenue by selling advertisement space on a webpage of the flower retailer for a particular duration of time. In a similar example, a sporting goods company may wish to display advertisements on webpages of a website related to sports, can purchase advertising space for a limited amount of time on that website. Thus, the buying and selling of advertising space can lead to increased revenue for a website owner (or content provider) as well as the advertiser. Moreover, the website owner need not be the retailed itself, but can be an intermediary website that routes to the retailer website.

In some conventional advertising enterprises, space on a website can be purchased in an auction manner. There may exist a plurality of advertising companies who are interested in purchasing space on a particular webpage for advertising purposes at specified times within a defined time range. These advertisers can enter bids for such space, and upon receipt of the triggering search term, the highest bid is accepted and the corresponding advertisement of the company that entered the highest bid is retrieved and displayed. The bids can be standing bids that expire after a certain amount of time, after a particular number of clicks on the advertisement, after a specified number of times that the bid is the highest bid, and generally based on any number of parameters. Furthermore, the bids can be dynamically adjusted, so that the bid is incrementally increased until that bid is the highest bid.

Various factors can be considered by an advertiser who enters a bid for space on a content provider webpage, including location of a portion of a website that will be utilized for advertising, size of the portion, length of time that the advertisement will be displayed, and the like. Moreover, content providers can auction space on webpages in a similar manner. For instance, each time a webpage is downloaded, an auction for portions of the page can be undertaken, given that the page real estate can be considered more valuable after each download.

Internet advertisers have recognized the value in focused advertising to users. That is, the return on investment (ROI) is higher when the advertising presented to the user is geared toward what the user is more likely to be interested in. For example, in the television environment, advertisements for a television show can be based roughly on the demographic of the viewing audience. When those advertisements are presented, the advertisers have limited mechanisms for determining the ROI for purchasing such advertising time and do not know if the viewer can even contact the advertisers.

Focused textual advertising is relatively new in Internet advertising and provides some level of focused advertising. There are an increasing number of businesses and/or websites offering contextual advertisements. A contextual advertisement is an advertisement based on the content of a webpage's surrounding text. Thus, if a review for a new camera phone, for example, is being viewed, the relevant contextual advertisement might be for a camera phone from a particular vendor. This results in users who are more pleased because the advertisements shown are actually relevant, and results in more satisfied advertisers because they get a much higher conversion rate for advertisements shown. Unfortunately, this technology only exists today for text-based advertisements.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

Briefly described, the subject innovation pertains to a distribution and contextual multimedia advertisement system based on the content of the media being consumed. For example, Sally, a New York City resident, is surfing the Internet and decides to watch a video of the recent episode of TV program. In the episode two of the characters go to the Metropolitan Museum of Fine Arts (“the Met”). Halfway through the episode, during a commercial break, a relevant multimedia advertisement for the Met is presented to Sally triggered for presentation in part due to the content of the TV program. Sally is pleased to see the multimedia advertisement and decides to go to the Met the following week.

The novel architecture disclosed and claimed herein, in one aspect thereof, comprises a distribution and contextual multimedia advertisement system based on the content of the media being consumed. The architecture includes a content component that determines content of a multimedia item, and a distribution component that facilitates presentation of one or more advertisements associated with the item content.

In another aspect of the subject innovation, the multimedia advertisement or advertisement content selected or generated can be based on information pertaining to a multidimensional item and/or end user as well as ratings influenced by advertisers, among other things

In yet another aspect thereof, a machine learning and reasoning (MLR) component is provided that employs a probabilistic and/or statistical-based analysis to prognose or infer an action that a user desires to be automatically performed such as presentation of information likely to be useful or beneficial to the user.

In accordance with another aspect of the innovation, advertisements can be presented or delivered at contextually valuable points in multimedia content. For example, advertisements can be presented at times or intervals more likely to have a stronger effect on users and evoke action. This increases both user and advertiser satisfaction with the system.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that facilitates contextual advertising in accordance with the subject innovation.

FIG. 2 illustrates a methodology of providing multimedia contextual advertising in accordance with an aspect.

FIG. 3 illustrates an alternative methodology of providing contextual multimedia advertising content in accordance with another aspect.

FIG. 4 illustrates a system of a more detailed composition of a distribution component.

FIG. 5 illustrates a more detailed system that provides contextual multimedia content in accordance with an innovative aspect.

FIG. 6 illustrates a methodology of providing multimedia content with rights protection in accordance with the disclosed innovation.

FIG. 7 illustrates a system that receives advertiser content and provider content, and distributes all content to an end user for viewing.

FIG. 8 illustrates a methodology of providing advertiser multimedia content in accordance with the disclosed innovation.

FIG. 9 illustrates an alternative methodology of providing advertiser multimedia content in accordance with the disclosed innovation.

FIG. 10 illustrates a methodology of providing advertiser multimedia content according to a bid and scheduling process in accordance with an aspect.

FIG. 11 illustrates metadata that can be employed and from which a contextual advertisement can be generated.

FIG. 12 illustrates a system that employs a machine learning and reasoning (MLR) component which facilitates automating one or more features in accordance with the subject innovation.

FIG. 13 illustrates a methodology of providing learning and reasoning in accordance with an innovative aspect.

FIG. 14 illustrates a block diagram of a computer operable to execute the disclosed architecture.

FIG. 15 illustrates a schematic block diagram of an exemplary computing environment.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The terms “multimedia item” or simply “item” are used herein to refer to media including one or more of video, audio, animation, graphics, images, interactive formats such as Flash, and the like. An “item” can also include text in addition to other types of content. However, an “item” is not meant to refer to an element of solely textual content. These items can be presented on, inter alia, a computer (e.g., via web page), a television, a personal digital assistant (PDA), a mobile phone, or other like device or displays.

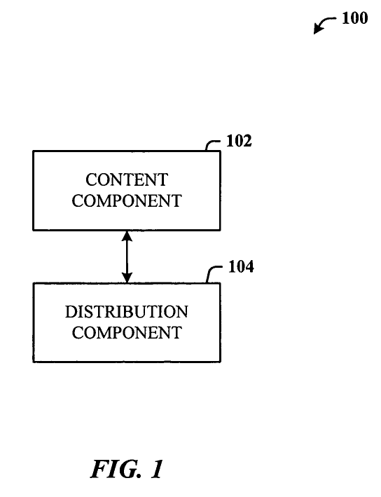

Referring initially to the drawings, FIG. 1 illustrates a system 100 that facilitates contextual advertising in accordance with the subject innovation. The system provides contextual multimedia advertising based on the content of a particular multimedia item. Accordingly, the system 100 can include a content component 102 that determines content of a multimedia item, and a distribution component 104 that facilitates presentation of relevant contextual multimedia content associated with the existing content of the item. For example, if the item is being presented for the first time, in many cases, the item already includes embedded content (also called surrounding content) that provides an indication to the system 100 of the content that is desired to be viewed by the user.

The content component 102 can analyze item content and the embedded surrounding content and determine characteristics thereof. Thus, when the user causes a multimedia item to be presented, the preprocessing phase analysis can begin. As will be discussed further in later sections, the content component 102 can analyze item and surrounding content utilizing automated analysis including but not limited to transcripts from speech to text, scene breakdown and visual analysis of images, shape recognition, visual similarity comparison and other image analysis techniques as well as receiving, retrieving, or otherwise obtaining explicit textual data associated with the item. Thereafter, the distribution component 104 receives the characteristics information from the content component 102, which is utilized to select the appropriate advertisement or advertising content that is relevant to the item content. The advertising content is then retrieved and added to the multimedia item, all of which is presented to the user.

In another aspect, the distribution component 104 receives user information, as well as item content characteristics information that are processed to select the relevant advertisement content for presentation. It is to be appreciated that any number or amount of information can be employed in determining what relevant advertisement to select for presentation with surrounding content of a multimedia item. Distribution component 104 can facilitate presentation of a relevant advertisement by adding it to the media signal, among other ways.

It should be noted that temporal proximity can be employed with respect to presentation of advertisement content by distribution component 104 to increase the effectiveness of the advertisements. In other words, advertisements can be presented where they are likely to have stronger effects on users and might be adjusted to evoke immediate action. This is likely to increase both user and advertiser satisfaction with the system. For example, assume Sally, a New York City resident, is surfing the Internet and decides to watch a video of the recent episode of TV program. In the episode, two of the characters go to the Metropolitan Museum of Fine Arts (“the Met”). Halfway through the episode, during a commercial break, a relevant multimedia advertisement for the Met is presented to Sally triggered for presentation in part due to the content of the TV program. Alternatively, the advertisement can be presented during the episode and the scene where the characters go to the Met, for instance, in a manner that does not obscure the video presentation. Sally is pleased to see the multimedia advertisement and decides to go to the Met the following week.

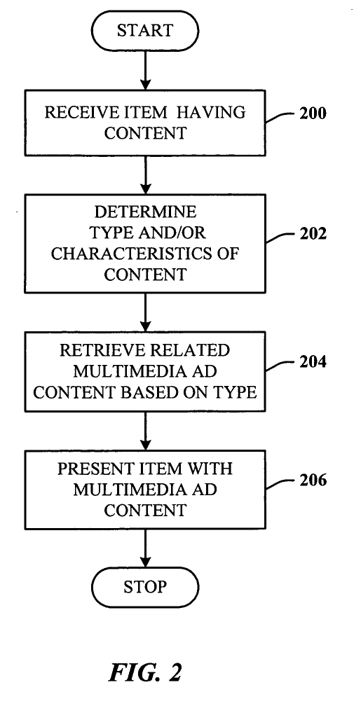

FIG. 2 illustrates a methodology of providing multimedia contextual advertising in accordance with an aspect. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At reference numeral 200, an item is received having content. At 202, characteristics of the surrounding content are determined (e.g., textual and/or multimedia). At 204, the relevant multimedia content is retrieved based on the type and/or characteristics of the surrounding content. At 206, the item content is presented with the multimedia advertisement content.

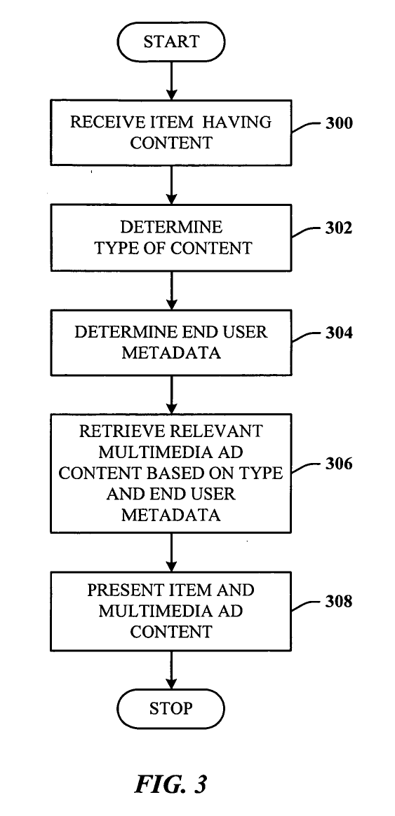

Referring now to FIG. 3, there is illustrated an alternative methodology of providing contextual multimedia advertising content in accordance with another aspect. At 300, an item is received for processing. At 302, the type and/or characteristics of the existing item content are determined. At 304, end user data metadata is determined. This will be described in greater detail infra. At 306, relevant multimedia advertisement content is retrieved based on the type of existing item content and the end user metadata. At 308, the multimedia advertisement content is presented (along with the existing item content) to the user.

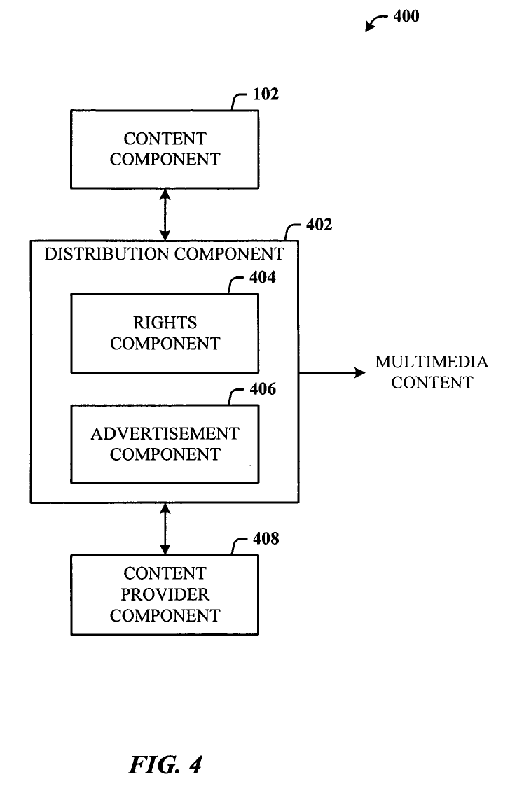

FIG. 4 illustrates a system 400 of a more detailed composition of a distribution component 402. Here, the distribution component 402 (similar to distribution component 104 of FIG. 1) includes a rights component 404 and an ad component 406. The rights component 404 facilitates rights protection of the multimedia content being provided for public distribution. For example, the rights component 404 can employ digital rights management (DRM) capability or capabilities of any other systems allowing control over aspects of the media (such as expiration of viewing rights) as a means of ensuring protection and accountability of presented content. The advertisement component 406 can include content that was uploaded from content provider(s) 408, which content is made readily available for distribution by the distribution component 402. The content component 102, as previously described, at least determines the existing content of an item such that relevant multimedia content can be selected and merged or added to the item for presentation of the user.

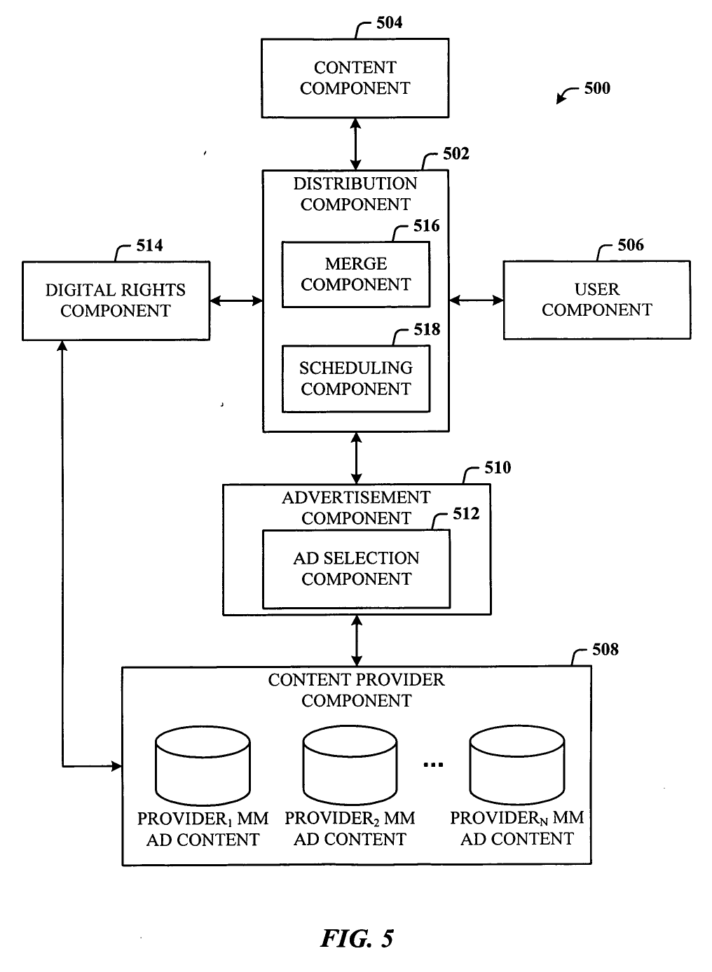

FIG. 5 illustrates a more detailed system 500 that provides contextual multimedia content in accordance with an innovative aspect. A core element of the system 500 is a distribution component 502 that communicates with several other components in furtherance of providing contextual multimedia content to a webpage. A content component 504, as before, at least performs analysis of the item in order to determine the existing surrounding context thereof. The existing item information is then passed to the distribution component 502. The system 500 further includes a user component 506 that determines and provides user metadata to the distribution component 502. Thus, in one implementation, the contextual multimedia content can be selected based at least upon the existing surrounding contextual data of the item and the user metadata.

A content provider component 508 of the system 500 receives and stores multimedia (MM) content from content providers. The content can be stored in separate stores of content (denoted PROVIDER₁ MM AD CONTENT, PROVIDER₂ MM AD CONTENT. . . , PROVIDERN_{N} MM AD CONTENT, where N is an integer). An advertisement component 510 interface to both the content provider component 508 and the distribution component 502 to facilitate selection of relevant multimedia advertisements from the content provider component 508. Accordingly, the advertisement component 510 can further include an advertisement selection component 512 that functions at least to make selections of the relevant multimedia content from the content provider component 508. Such content can be uploaded to facilitate advertiser competition including but not limited to auction style biding. The selection process can include a number of criteria, for example, the time required to play the multimedia content, the physical dimensions required for any video or image data to be presented, the amount of the bid placed to present the content, and so. These criteria are described in greater detail herein below.

The system 500 can also include a digital rights component 514 that interfaces to the content provider component 508 and the distribution component 502 to facilitate adding digital rights protection technology (e.g., DRM) to the selected content multimedia before distribution. Alternatively, it is to be appreciated the digital rights data can be added to the content by the content provider before supplying the content to the content provider component 508.

Once the existing surrounding item content has been ascertained, the relevant multimedia content selected (and with rights protection added), the user metadata considered (if desired), the distribution component 502 can merge or add all this information to the item for distribution to the end user. Accordingly, the distribution component 502 can further include a merge component 516 that performs the merge operation. It is to be appreciated that the merge operation can be performed at the end user machine such that the distribution component 502 transmits all the necessary item content thereto, after which the end user machines performs the assembly operation to present the final item content to the end user.

The distribution component 502 can also include a scheduling component 518 that processes and applies scheduling data to the item when distributed. For example, it can be possible for an advertiser to choose to have the selected content to be presented at predetermined intervals over a five minute segment of allowed advertising time. In other words, the content will be presented and replayed every thirty seconds over a five-minute time span, after which the content will be removed for the next bid cycle. Alternatively, the content can be replayed based on certain triggers that initiate replay (or re-presentation) of the content. For example, if the user refreshes the webpage on which the item resides, or the webpage is automatically refreshed, the multimedia content will be played again.

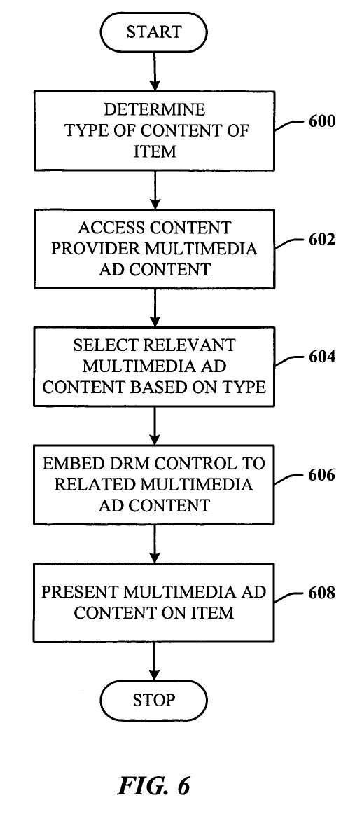

Referring now to FIG. 6, there is illustrated a methodology of providing multimedia content (e.g., advertisement) with right protection in accordance with the disclosed innovation. At 600, an item is received and the existing content analyzed and determined. At 602, a content provider of the multimedia content is accessed for advertisement content. At 604, relevant multimedia content is selected based on the existing item content type. At 606, digital rights control technology data is embedded in the selected multimedia content for rights protection when distributed. At 608, the multimedia advertisement content is presented on the item along with the existing surrounding content to a user.

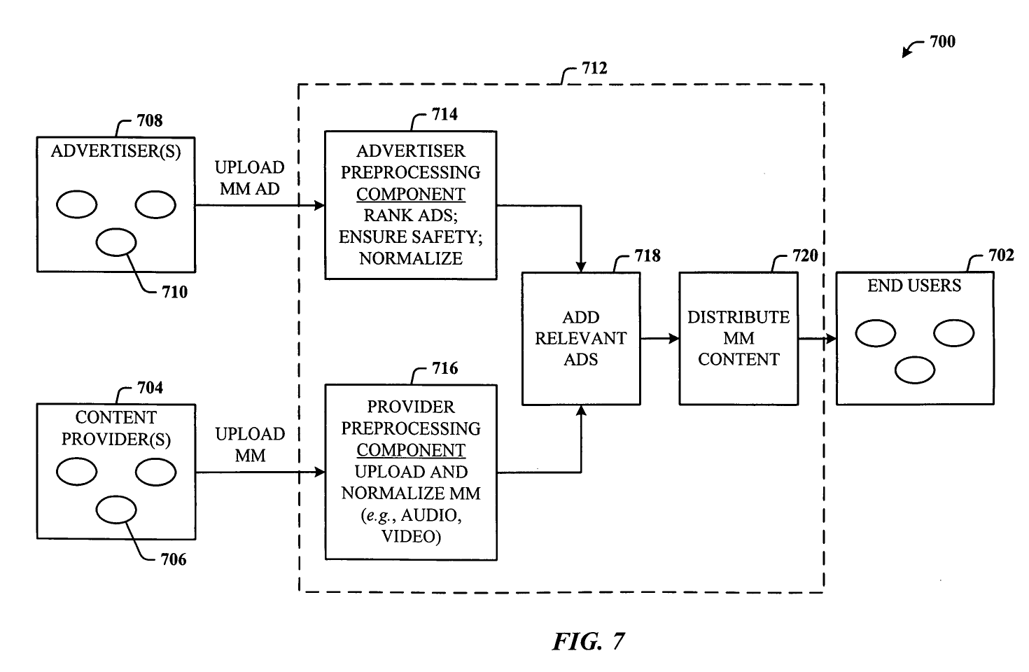

FIG. 7 illustrates a system 700 that receives advertiser content and provider content, and distributes all content to an end user 702 for viewing. The system 700 includes a content provider 704 that provides content 706 to an item for presentation. The system 700 facilitates contextual advertising by further including an advertiser 708 that offers multimedia advertisement content 710 by bidding (and ultimately paying) on presentation opportunities relevant to its content. The advertiser(s) 708 will be able to upload and bid on their own advertisement placement. Thus, for example, if fifteen advertisers bid on the keyword “shoe”, then the highest bidder will get advertisement placement with the first occurrence of shoe, the second at the second, and on down. The advertisements will be added at viewing time, so one video can at different times display different advertisements. Likewise, if there is information about the viewer that can be added into the equation as well, so an advertiser can bid both on the content keyword “shoe” and the demographic data of “male, age 13-18”. Once the advertisements are uploaded, they are adapted for acceptable content and with regards to volume, file type and potentially color, speed and effects usage, for example.

Content (e.g., text, audio, video, . . . ) from both the content provider 704 and the advertiser 710 can be uploaded to a distribution network 712, wherein the advertiser content is uploaded to an advertiser preprocessing component 714 that ranks or prioritizes all received multimedia advertisement content, ensures the safety thereof by employing digital rights technology so that the advertiser can retain control of the content after distribution, screens the content for suitable and/or acceptable content, and normalizes the content with regard to, for example, volume, file type, and potentially, color, speed of execution, and effects usage.

Similarly, the distribution system 712 also includes a provider preprocessing component 716 that receives and normalizes the provider content. The output of each of the advertiser and provider preprocessing components (714 and 716) is then passed to a merge component 718 that merges all the associated and selected content into the item. The data is then distributed via a multimedia distribution component 720 that facilitates the distribution of at least audio and/or video content to the end user 702 for presentation. The distribution can be via a mass storage device and/or a peer-to-peer mechanism, for example.

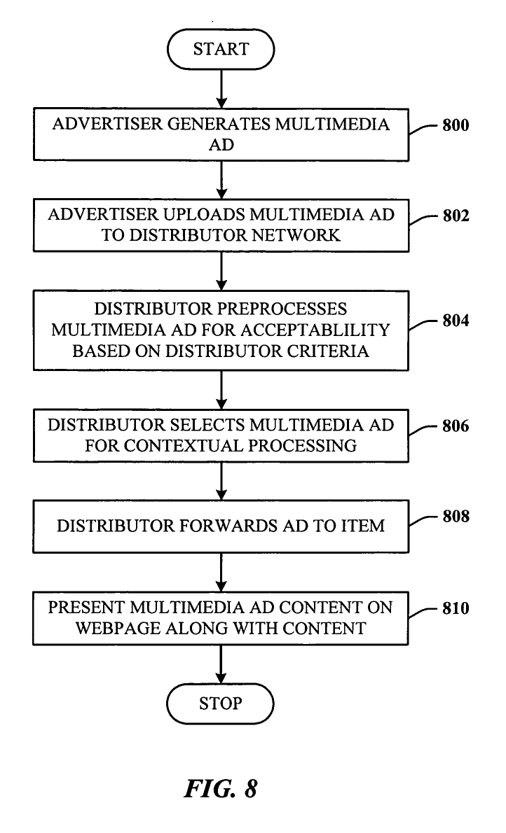

FIG. 8 illustrates a methodology of providing advertiser multimedia content in accordance with the disclosed innovation. At 800, the advertiser generates a multimedia advertisement. At 802, the advertiser uploads the multimedia advertisement to a distributor network. At 804, the distributor network preprocesses the multimedia advertisement for acceptability based on distributor criteria. for example, if the distributor determines that the content is that which is deemed unacceptable for further distribution, the content can be discarded or stored for updating by the advertiser that then bring the content into acceptable standards set by the distributor. At 806, the distributor selects the advertisement for contextual processing. At 808, the distributor forwards the multimedia advertisement to item processing. At 810, the relevant multimedia advertisement is presented along with other contextual content to the end user.

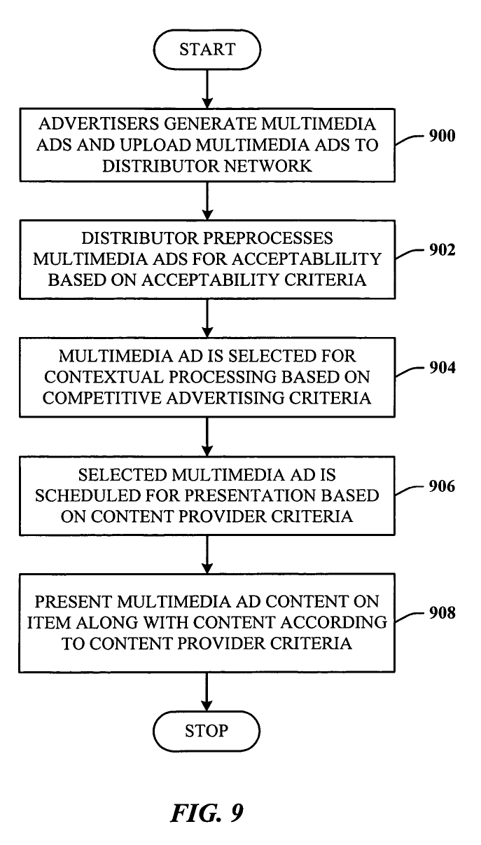

FIG. 9 illustrates an alternative methodology of providing advertiser multimedia content in accordance with the disclosed innovation. At 900, the advertiser generates and uploads multimedia advertising content to the distributor network. At 902, the distributor preprocesses the multimedia content for acceptability based on acceptability criteria. At 904, the multimedia advertisement is selected for contextual processing based on competitive advertising criteria (e.g., a bid or auction process). At 906, the selected multimedia advertisement content is scheduled for presentation based on content provider criteria. For example, the provider requires that three minutes of advertisements are to be prepended at the start of a video clip and two minutes of advertisements are to be presented at a twenty-minute mark and a forty-minute mark of the video presentation. At 908, the multimedia content is presented on the item along with the surrounding content according to the provider criteria.

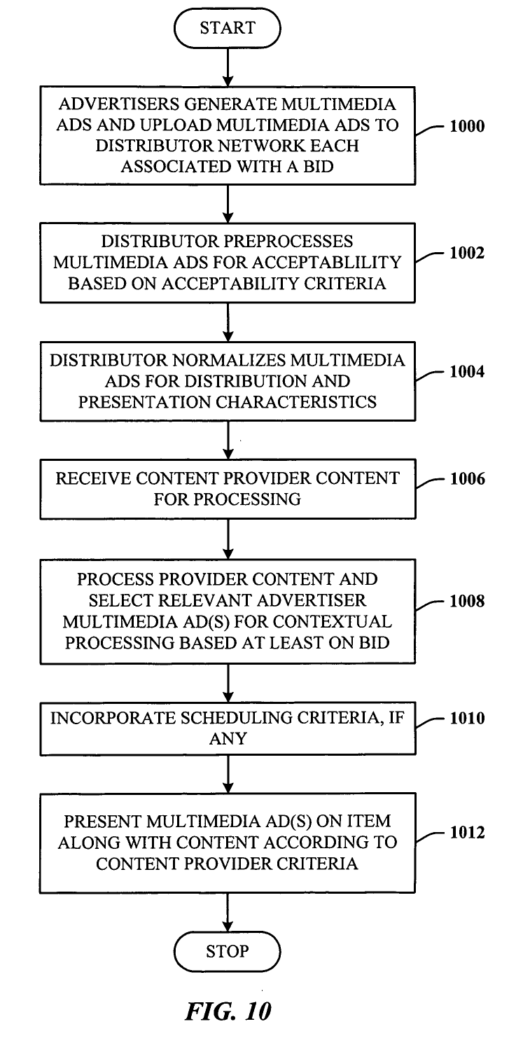

FIG. 10 illustrates a methodology of providing advertiser multimedia content according to a bid and scheduling process in accordance with an aspect. At 1000, advertisers generate multimedia advertisements and upload the advertisements to a distributor network. At 1002, the distributor preprocesses the multimedia advertisement(s) for acceptability based on acceptability criteria (e.g., adult content may not be allowed). At 1004, the distributor normalizes or adapts the multimedia content for distribution and presentation characteristics. As described supra, normalization can include ensuring that the content (e.g., audio, image and/or video) can be executed in the time allotted for the advertisement, that the content file type is supported or file size is wieldy, etc. At 1006, the content is then received for processing. At 1008, the provider content is processed for selecting relevant advertiser multimedia advertisements for contextual processed based at least on a bid offered by the advertiser. At 1010, if any scheduling criteria are proposed by the advertiser and/or the provider, this can also be considered as part of the selection process. At 1012, the multimedia advertisement(s) are presented in the item along with other contextual information according to the content provider criteria.

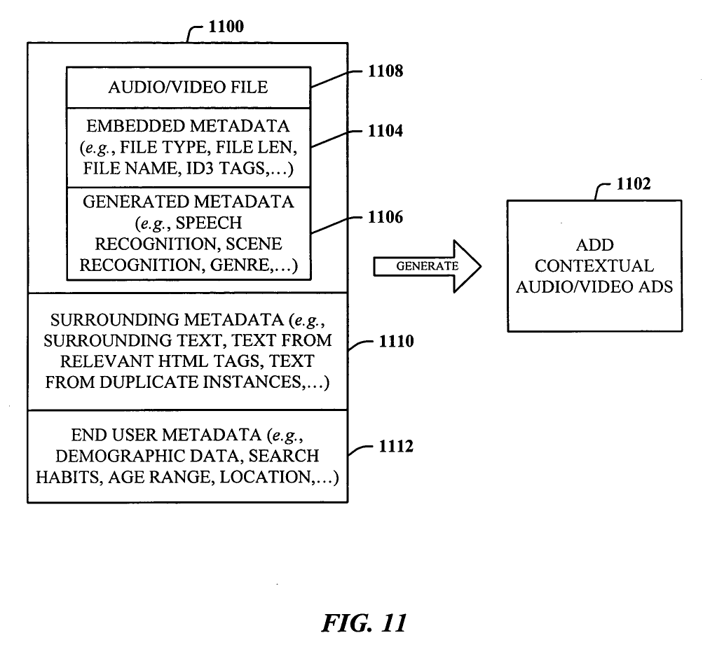

FIG. 11 illustrates metadata 1100 that can be employed and from which a contextual advertisement 1102 can be generated or selected. A contextual advertisement 1102 can be generated or selected from the content of various sources of data or metadata related to a media item. These sources can include but are not limited to one or more of the following: embedded metadata 1104 in an item, such as file name, file length, file type, metadata tags (e.g., ID3), etc.; generated or otherwise acquired metadata 1106 from item content (e.g., speech recognition, scene recognition, transcripts from speech to text, face recognition, genre, . . . ); audio and/or video file content 1108, surrounding metadata 1110 (e.g., surrounding text, text from relevant HTML tags, text from duplicate instances,. . . ); and end user metadata 1112 (e.g., demographic and/or psychographic data, search habits, age range, location, Internet use patterns, . . . ). For example, satellite radio receivers are coded for individual use. Information from such receivers or the like can be employed to obtain demographic and/or geographic metadata concerning a user. As another example, close-caption like systems or algorithms can be executed to convert sound signals to text. Existing keyword extraction algorithms can be run to facilitate comprehension of the context.

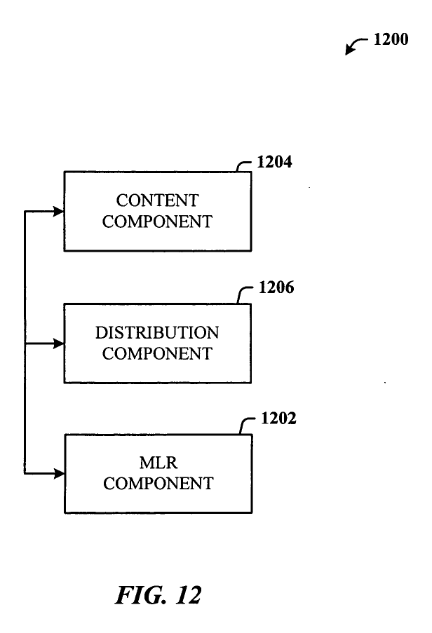

FIG. 12 illustrates a system 1200 that employs a machine learning and reasoning (MLR) component (or simply machine learning component) which facilitates automating one or more features in accordance with the subject innovation. The MLR component 1202 interfaces to a content component 1204 (similar to content component 102 of FIG. 1) and a distribution component 1206 (similar to distribution component 104 of FIG. 1). The subject invention (e.g., in connection with selection) can employ various MLR-based schemes for carrying out various aspects thereof. For example, a process for determining what criteria to employ during an advertisement selection process can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed. In the case of items, for example, attributes can be words, phrases, images or other data-specific attributes derived therefrom the (e.g., key terms), and the classes are categories or areas of interest (e.g., levels of priorities).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions, including but not limited to determining what criteria to employ when selecting multimedia advertisement, what analysis should be applied in analyzing the existing item content, how relevant are the proposed multimedia advertisements, and so on.

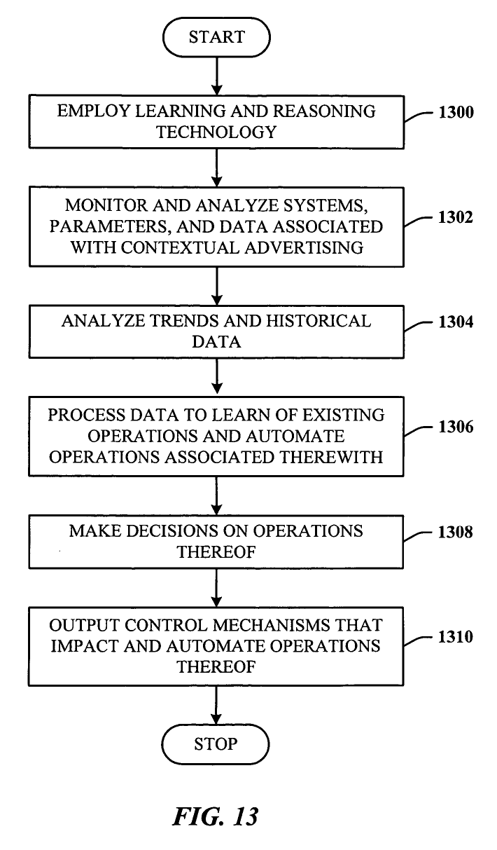

FIG. 13 illustrates a methodology of providing learning and reasoning in accordance with an innovative aspect. At 1300, learning and reasoning is employed for automation one or more aspects thereof. At 1302, one or more systems are monitored and analyzed and, parameters and data associated with contextual advertising. At 1304, data trends and historical data are analyzed. At 1306, data is processed to learn of existing operations and to automate operations associated therewith. At 1308, decisions re made related to operations. At 1310, control is exercised over mechanism that impact and automate operations of the system.

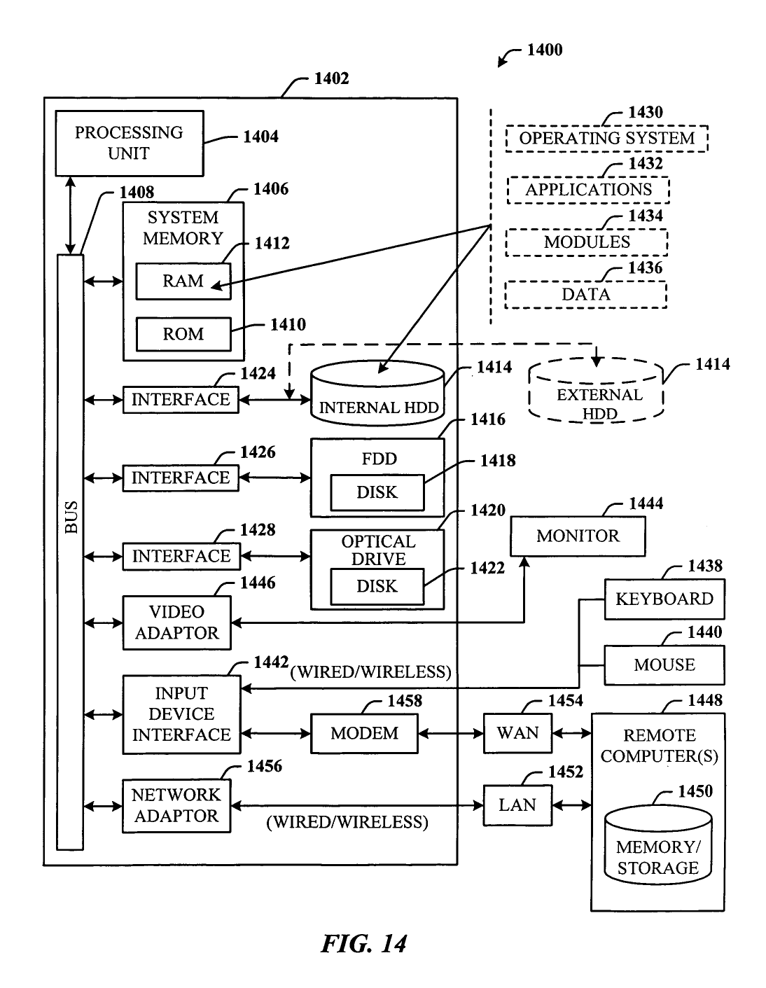

Referring now to FIG. 14, there is illustrated a block diagram of a computer operable to execute the disclosed architecture. In order to provide additional context for various aspects thereof, FIG. 14 and the following discussion are intended to provide a brief, general description of a suitable computing environment 1400 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 14, the exemplary environment 1400 for implementing various aspects includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is to be appreciated that the innovation can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 1408 via an interface, such as a video adapter 1446. In addition to the monitor 1444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adaptor 1456 may facilitate wired or wireless communication to the LAN 1452, which may also include a wireless access point disposed thereon for communicating with the wireless adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and BluetoothTM wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

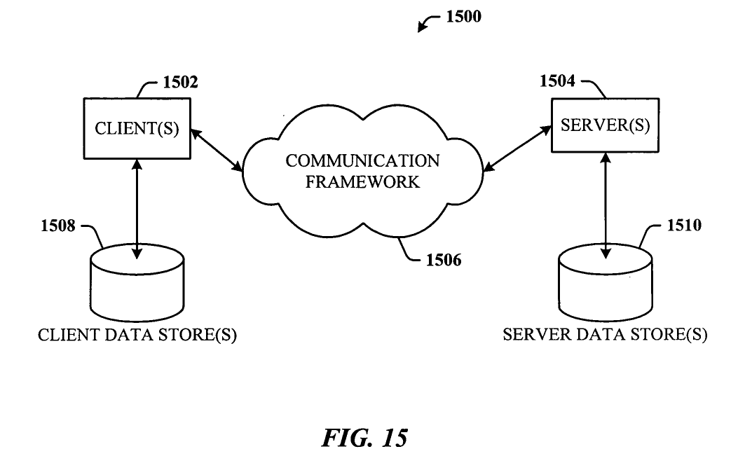

Referring now to FIG. 15, there is illustrated a schematic block diagram of an exemplary computing environment 1500 in accordance with another aspect. The system 1500 includes one or more client(s) 1502. The client(s) 1502 can be hardware and/or software (e.g., threads, processes, computing devices). The client(s) 1502 can house cookie(s) and/or associated contextual information by employing the subject innovation, for example.

The system 1500 also includes one or more server(s) 1504. The server(s) 1504 can also be hardware and/or software (e.g., threads, processes, computing devices). The servers 1504 can house threads to perform transformations by employing the invention, for example. One possible communication between a client 1502 and a server 1504 can be in the form of a data packet adapted to be transmitted between two or more computer processes. The data packet may include a cookie and/or associated contextual information, for example. The system 1500 includes a communication framework 1506 (e.g., a global communication network such as the Internet) that can be employed to facilitate communications between the client(s) 1502 and the server(s) 1504.

Communications can be facilitated via a wired (including optical fiber) and/or wireless technology. The client(s) 1502 are operatively connected to one or more client data store(s) 1508 that can be employed to store information local to the client(s) 1502 (e.g., cookie(s) and/or associated contextual information). Similarly, the server(s) 1504 are operatively connected to one or more server data store(s) 1510 that can be employed to store information local to the servers 1504.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A contextual advertisement system comprising the following computer executable components:
a content component that determines content of a multimedia item; and
a distribution component that facilitates presentation of one or more advertisements associated with the content.

2. The system of claim 1, the advertisement includes at least one of audio, video, animation, graphics, images, links, and alphanumeric characters.

3. The system of claim 1, the advertisement is presented in the item and/or close temporal or physical proximity to associated item content.

4. The system of claim 1, the advertisement is presented in the item, the advertisement is based in part on the content and user data.

5. The system of claim 4, the user data includes at least one of user demographic, geolocation, behavioral and psychographic information.

6. The system of claim 1, further comprising a component that employs a probabilistic and/or statistical analysis to infer advertisements for presentation that would be beneficial to a user.

7. The system of claim 1, further comprising a scheduling component that schedules when the one or more advertisements are presented.

8. The system of claim 1, an advertisement is presented based on payment of an advertiser.

9. The system of claim 1, the distribution component ranks the available multimedia advertisements according to one or more criteria.

10. The system of claim 1, the advertisement is computed to be relevant to the content.

11. The system of claim 13, the advertisement is presented based on data including at least one of embedded metadata, inferred metadata, and item context.

12. A computer-implemented method of providing contextual advertising, comprising the following computer executable acts:
analyzing a multimedia item; and
selecting or generating advertising content relevant to item content.

13. The method of claim 12, further comprising presenting the item content and the advertising content to a user.

14. The method of claim 12, further comprising selecting or generating the advertising content based upon relevant item metadata.

15. The method of claim 12, further comprising selecting or generating the advertising content based upon end user data.

16. The method of claim 15, selecting advertising content based on user demographic, geolocation, psychographic, and/or behavior information.

17. The method of claim 12, further comprising scheduling presentation of the advertising content during one or more time intervals.

18. The method of claim 12, analyzing the multimedia item comprises:
converting speech to text; and
executing keyword extraction algorithms on the text.

19. The method of claim 12, analyzing the multimedia item comprises executing one or more image analysis techniques.

20. A computer-implemented system, comprising:
computer-implemented means for analyzing item content;
computer-implemented means for selecting advertising content that is relevant to the item content; and
computer-implemented means for adding advertising content to the item content.
